(19) United States
(12) Patent Application Publication
(10) Pub. No.: US 2017/0300599 A1
(43) Pub. Date: Oct. 19, 2017

(54) SYSTEM AND METHOD FOR CALIBRATING MULTI-LEVEL BUILDING ENERGY SIMULATION

(71) Applicant: University of Southern California, Los Angeles, CA (US)

(72) Inventors: Burcin Becerik-Gerber, Los Angeles, CA (US); Zheng Yang, Cerritos, CA (US)

(21) Appl. No.: 15/490,610

(22) Filed: Apr. 18, 2017

Related U.S. Application Data
(60) Provisional application No. 62/324,178, filed on Apr. 18, 2016.

(51) Int. Cl. G06F 17/50

(52) U.S. Cl. CPC G06F 17/5004; G06F 17/5009

(57) ABSTRACT

Methods and systems for simulating energy use in a building is described. The method includes generating a building model based on building data associated with the building, the building model having a plurality of levels, the building model simulating the energy use in the building based on values of input parameters. The method includes receiving detected energy data associated with actual energy use in the building. The method includes performing a sensitivity analysis using the building model to identify influential parameters. The method includes performing a discrepancy analysis across the plurality of levels using the building model and the detected energy data to identify adjustable parameters. The method includes determining values for the identified adjustable parameters to minimize discrepancies at the plurality of levels. The method includes incorporating the values for the identified one or more adjustable parameters into the building model to provide a calibrated building model.

### CROSS REFERENCE TO RELATED APPLICATIONS

This application claims the benefit and priority of U.S. Provisional Application No. 62/324,178, filed on Apr. 18, 2016, entitled “Calibration for Multi-Level Building Energy Modelling,” the contents of which are herein incorporated by reference in its entirety.

### GOVERNMENT LICENSE RIGHTS

This invention was made with government support under Grant Nos. 1351701 and 1201198 awarded by the National Science Foundation. The government has certain rights in this invention.

### BACKGROUND

### 1. Field of the Invention

The present invention relates to building energy use simulations, and more particularly to calibrating building models.

### 2. Description of the Related Art

Buildings account for one-third of the total global energy consumption. In the commercial building sector, more than 80% of building energy consumption occurs during the operation phase to maintain indoor environments and provide building-based services. By analyzing the differences between the actual energy consumed and the energy required to satisfy building operation demands, it has been determined that up to 30% of the thermal energy and 13% of the electrical energy could be saved if energy conservation measures (ECMs) were to be adopted in office buildings. Simulation, the virtual representation and reproduction of building energy process, is widely used for integrating heat and mass transfer, environmental data, and load-HVAC interactions, as well as generating periodical energy performance estimates for building systems, such as HVAC (heating, cooling and air conditioning) systems. Compared to field experiment, simulation has several advantages: (1) simulation allows analysts to evaluate the system performances when field experiments are infeasible; (2) simulation facilitates the investigation of various ECMs before being implemented; (3) simulation is less expensive and less time consuming; (4) simulation can be reversed after implemented; (5) simulation can control factors that cannot be controlled in a field experiment (e.g., weather conditions); (6) simulation is non-intrusive for a building and its occupants; (7) simulation outputs different performance indicators, which are hard to be metered in field experiments; and (8) simulation makes it easier for analysts to interpret results.

Despite its advantages, expected energy savings from relatively optimal ECMs determined in simulations do not usually match those measured (or detected) in actual buildings due to the discrepancies between actual buildings and their virtual representations. Empirical studies have revealed noticeable differences between simulation results and actual measurements. Simulated results sometimes deviate significantly from the measured ones. When a simulation model is not accurate, it may mislead and impair the design and implementation of ECMs. The accuracy of a simulation model largely depends on how well the outputs are compatible with available measured data, which in turn depends on how accurate the inputs could empirically reproduce the properties of a building the model simulates.

### SUMMARY OF THE INVENTION

According to some embodiments, a method for simulating energy use in a building is described. The method includes generating a building model based on building data associated with the building, the building model having a plurality of levels each representing a scope of energy use, the building model simulating the energy use in the building based on one or more values corresponding to one or more input parameters to produce building model simulation results. The method also includes receiving detected (or measured) energy data associated with actual energy use in the building over a period of time. The method also includes performing a sensitivity analysis using the building model to identify one or more influential parameters affecting building energy simulation results. The method also includes performing a discrepancy analysis across the plurality of levels using the building model and the detected energy data to identify one or more adjustable parameters from the one or more influential parameters. The method also includes determining values for the identified one or more adjustable parameters to minimize discrepancies at the plurality of levels. The method also includes incorporating the values for the identified one or more adjustable parameters into the building model to provide a calibrated building model for simulating energy use in the building.

In some embodiments, a method for calibrating a building model used to simulate energy use in a building having a plurality of levels each representing a scope of energy use is described. The building model simulates the energy use in the building based on the values of one or more input parameters. The method includes receiving, by a building simulation unit, detected energy data associated with the building over a period of time. The method also includes performing, by a sensitivity unit, a sensitivity analysis using the building model to identify one or more influential parameters from the one or more input parameters. The method also includes performing, by a discrepancy processing unit, a discrepancy analysis across the plurality of levels using the building model and the detected energy data to identify one or more adjustable parameters from the one or more influential parameters. The method also includes determining, by the discrepancy processing unit, values for the identified one or more adjustable parameters to minimize discrepancies at the plurality of levels. The method also includes incorporating, by a calibration unit, the values for the identified one or more adjustable parameters into the building model to provide a calibrated building model for simulating energy use in the building.

In some embodiments, a system for simulating energy use in a building is described. The system includes a modeling unit configured to generate a building model based on building data associated with the building, the building model having a plurality of levels each representing a scope of energy use, the building model simulating the energy use in the building based on one or more values corresponding to one or more input parameters to produce building model simulation results. The system also includes a calibration unit connected to the modeling unit and configured to receive detected energy data associated with the building over a period of time. The system also includes a sensitivity unit connected to the calibration unit and configured to perform a sensitivity analysis using the building model to identify one or more influential parameters from the one or more input parameters. The system also includes a discrepancy processing unit connected to the calibration unit. The discrepancy processing unit is configured to perform a discrepancy analysis across the plurality of levels using the building model and the detected energy data to identify one or more adjustable parameters from the one or more influential parameters. The discrepancy processing unit is also configured to determine values for the identified one or more adjustable parameters to minimize discrepancies at the plurality of levels. The calibration unit is further configured to incorporate the values for the identified one or more adjustable parameters into the building model to provide a calibrated building model for simulating energy use in the building.

### BRIEF DESCRIPTION OF THE DRAWINGS

The features and advantages of the embodiments of the present disclosure will become more apparent from the detailed description set forth below when taken in conjunction with the drawings. Naturally, the drawings and their associated descriptions illustrate example arrangements within the scope of the claims and do not limit the scope of the claims. Reference numbers are reused throughout the drawings to indicate correspondence between referenced elements.

FIG. 1A illustrates an exemplary building, according to an embodiment of the invention.

FIG. 1B illustrates an exemplary simulation model of the building, according to an embodiment of the invention.

FIG. 2 illustrates a building energy use simulation system, according to an embodiment of the invention.

FIG. 3 illustrates an exemplary classification schema for input parameters for the building model, according to an embodiment of the invention.

FIG. 4A illustrates a method of calibrating the building energy model, according to an embodiment of the invention.

FIG. 4B illustrates a method of calibrating the building energy model, according to an embodiment of the invention.

FIG. 5 illustrates an exemplary user interface for interacting with the building simulation unit, according to an embodiment of the invention.

FIG. 6 illustrates the mean and standard deviation of the elementary effects for each parameter in an experiment using the systems and methods described herein, according to an embodiment of the invention.

FIG. 7 illustrates multi-regression analysis results at the building level in an experiment using the systems and methods described herein, according to an embodiment of the invention.

FIG. 8 illustrates multi-regression analysis results at the ECM level in an experiment using the systems and methods described herein, according to an embodiment of the invention.

FIG. 9 illustrates multi-regression analysis results at the zone level in an experiment using the systems and methods described herein, according to an embodiment of the invention.

FIG. 10 illustrates data collection periods in an experiment using the systems and methods described herein, according to an embodiment of the invention.

FIG. 11 illustrates convergence results for different combinations of preferred weights in an experiment using the systems and methods described herein, according to an embodiment of the invention.

FIG. 12 illustrates MBE values for a calibrated model in an experiment using the systems and methods described herein, according to an embodiment of the invention.

FIG. 13 illustrates CV(RMSE) values for a calibrated model in an experiment using the systems and methods described herein, according to an embodiment of the invention.

FIG. 14 illustrates MBE values and CV(RMSE) values for a calibrated model at the ECM level in an experiment using the systems and methods described herein, according to an embodiment of the invention.

FIG. 15 illustrates a comparison of simulated temperature and actual temperature for randomly selected zones in an experiment using the systems and methods described herein, according to an embodiment of the invention.

### DETAILED DESCRIPTION

In the following detailed description, numerous specific details are set forth to provide an understanding of the present disclosure. It will be apparent, however, to one of ordinarily skilled in the art that elements of the present disclosure may be practiced without some of these specific details. In other instances, well-known structures and techniques have not been shown in detail to avoid unnecessarily obscuring the present disclosure.

In general, energy model calibration is a context-related process involving many input parameters. In order to calibrate an energy model for a building, input values may be tuned to reconcile the output by a simulation program as closely as possible to detected energy data. There may be a large number of independent and interdependent input parameters to be specified, which represent the complex correlations and dynamic interactions among envelope thermal conditions, HVAC responses, exterior impacts (e.g., solar radiation) and interior impacts (e.g., light related heat gains). They cannot always be determined by available evidence in calibration. Two sources are recognized to be generally responsible for discrepancies in building energy simulation. One is the uncertainty in input parameters and the other one is the simplification of building and building systems, assumptions of thermal processes, and algorithmic differences used in simulation programs. Since the second source of error depends on the simulation program chosen, the systems and methods described herein focus on the first source of error: reducing the discrepancies in outputs caused by the uncertainty of input parameters.

Conventional calibration methods focus on single-level simulation accuracy. As used herein, a level may refer to a scale or scope of simulation using a model. A single level of calibration considers the accuracy for one scale of output in an energy simulation, such as building level gas consumption or zone level electricity consumption. Since there are a large number of input parameters but few output variables (depending on the required resolution and the length of simulation), approximate high accuracy for a single level of simulation is possible. However, simultaneous accuracy for multiple levels of simulation is much more difficult. Multiple levels of simulation may include, for example, building level accuracy providing insight about overall energy performance of a building and building systems; ECM level accuracy representing the direct energy consequences of applying a certain type of energy conservation measure; and zone level accuracy decomposing energy consumption by a zone that is the control unit for heat balance and load calculations, and closely relating to occupant comfort and building system functionality. As used herein, an ECM may refer to a specific HVAC control strategy.

Although different levels of energy consumptions are interconnected and they reflect the approximation of simulation results to the measured (or detected) energy performance, accurate simulation of a single level does not necessarily mean accurate simulations for other levels, particularly when there are several zones and multiple HVAC units in a building. It may be more difficult to achieve high accuracies for multiple levels of simulations simultaneously, as the complexity increases due to the complicated and dynamic correlations and interactions among envelope thermal conditions, HVAC responses, exterior impacts, and interior impacts. Accordingly, determining energy-efficient measures in a building includes more than one level of energy performance and may include other levels of energy simulation for analysis. Therefore, the systems and methods described herein include multi-level calibration to achieve multiple calibration objectives simultaneously.

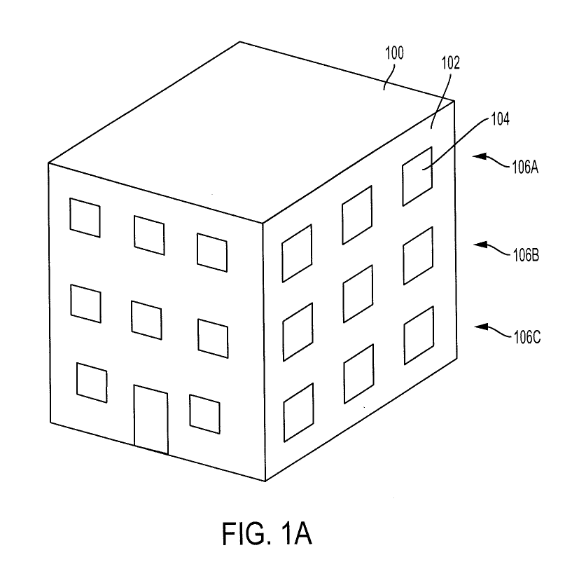

FIG. 1A illustrates an exemplary building 100. The building 100 is made of one or more materials to form the structure 102, and includes a plurality of windows 104. The building 100 has multiple floors 106A-106C. The owner of the building 100 may desire to implement various measures to reduce the energy used by the building 100. For example, the schedule or rules by which air conditioning or heating is engaged in the building 100 may be adjusted, in order to conserve energy. However, making the adjustments and empirically observing energy used by the building to determine whether there is a reduction in energy costs is both time-intensive and imprecise, as other factors may be responsible for changes in energy use.

Instead, a simulation model may be used, as illustrated in FIG. IB. The simulation model 160 of the virtual building 150 simulates the conditions of the actual building 100 under various test rules. The building 100 may be divided into floors 106, rooms, or zones. The rooms may be represented in the virtual rooms 164 in the virtual building 150 and the zones may be represented in the virtual zones 166 in the virtual building 150. As described herein, the floors, rooms, or zones may be examples of levels by which energy use may be measured. The simulation model 160 is displayed on a display 162. The display 162 may refer to the hardware display and/or the user interface by which various graphics are rendered for viewing by a user. Unfortunately, conventional building simulation is subject to high error rates, and when the simulation is inaccurate, it is not reliable.

Building simulation may be subject to error because of the complex correlations and dynamic changes in envelope thermal conditions, exterior impacts (e.g., solar radiation) and interior impacts (e.g., light related heat gain), as well as because of the large number of independent and interdependent input parameters, which may not be all obtained empirically. The time and effort required to collect data and determine input parameters make energy model calibration a challenge for large-scale applications.

Each building may be modeled and calibrated individually, and an ECM may be specifically designed for a particular building. Using typical or standard values for input parameters or estimating energy performance based on similar building data does not provide accurate energy model calibration for a given building. A generally adopted methodology by which building energy models should be calibrated may be challenging because of the different requirements for simulations, different purposes of simulations, different configurations of building systems, different available evidence and different levels of knowledge and experience of analysts.

Statistical learning based calibration methods may be used to model a building, but in view of the large number of parameters to be considered, learning model training is computationally expensive and may not provide acceptable solutions because of overfitting. In addition, accurate energy model calibration is a case-by-case process; machine-learning models generated from reference buildings may not be applicable to other buildings, even if they are located in the same climate.

Analytical calibration methods may be used to model a building, but they include a trial and error process, where there are large numbers of parameters. It may not be reliable as the complexity of the simulated building increases. Even if each input parameter is empirically validated, the simulation output of a building may still be far from measured building performance, since buildings do not always behave as initially designed. Continuous updates for input parameters may be necessary for calibration. Quality of the analytic calibration model relies heavily on the subjective judgment of an analyst on building systems and thermal processes, especially in the choice of parameters to be calibrated, quantification of their prior distribution, best guesses of parameter estimation, and interrelations among parameters. High accuracy at multiple levels is difficult to be achieved solely with this method.

To estimate potential energy savings when different ECMs are evaluated, a model may be sensitive to the changes resulting from the building being operated differently. In an example embodiment, ground truth energy data (or detected energy data) from implementations of two ECMs may be used to calibrate the model, and the model may achieve consistent performance for either ECM.

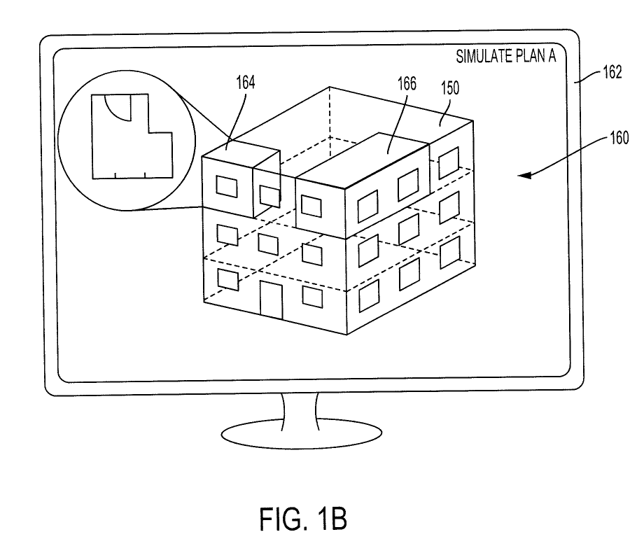

FIG. 2 illustrates a building energy use simulation system 200. The building energy use simulation system 200 includes a building simulation unit 202 connected to an input device 204, such as a computer mouse or keyboard, for example. The input device 204 is configured to receive an input from the user and communicate the input to the building simulation unit 202. The input from the user may be keystrokes or mouse movements, and may identify locations of data stored in memory 220. The input from the user may also be an uploading or transmitting of data to the building simulation unit 202.

The building simulation unit 202 is also connected to a display 206 configured to display an output to the user. In some embodiments, the display 206 shows a visual representation of the building to be simulated, and whether the simulation is an accurate one, based on the calibration. The building simulation unit 202 is also connected to one or more sensors 208, each configured to detect environment data associated with a building. In some embodiments, the sensors 208 include a temperature sensor configured to detect a temperature. In some embodiments, the sensors 208 include an energy use sensor configured to detect an amount of energy being used in a building or in a part of a building. In some embodiments, the sensors 208 include a motion detector configured to detect the presence of a moving person or object in proximity to the motion detector. The sensors 208 may be used to initially generate the building model and/or to calibrate the model.

The building simulation unit 202 includes a modeling unit 210 configured to construct an initial building model. In some embodiments, the modeling unit 210 is configured to adjust the initial model and generate an updated building model. The building model may be updated based on calibration data from the calibration unit 212. The building model and/or the update building model may be stored in memory 220.

The building simulation unit 202 also includes a calibration unit 212. The calibration unit 212 is configured to calibrate the building model constructed by the modeling unit 210. In some embodiments, the calibration unit 212 is configured to calibrate a building model stored in memory 220. In some embodiments, the calibration unit 212 determines calibration data and communicates the calibration data to the modeling unit 210 to update the building model. In some embodiments, the calibration data is a set of values for particular input parameters.

The calibration unit 212 includes a sensitivity unit 214, parameter estimation unit 216, and a discrepancy processing unit 218, each as described herein. Each of the units described herein (e.g., building simulation unit 202, modeling unit 210, calibration unit 212, sensitivity unit 214, parameter estimation unit 216, and discrepancy processing unit 218) may be implemented as a processor configured to execute instructions stored on the memory 220.

The memory 220 may be a non-transitory computer-readable memory configured to store data, including instructions executed by a processor, or data associated with the building model and used to calibrate the building model.

The sensitivity unit 214 is configured to determine, from a plurality of parameters, one or more parameters according to an impact on the energy use of the building. Since an energy simulation model may have large amounts of input parameters that cannot be all determined by available evidence, a classification schema may be created and all of the input parameters may be classified into hierarchical categories for calibration. In some embodiments, the calibration unit 212 is responsible for constructing the classification schema. In some embodiments, the classification schema is provided to the calibration unit 212 by the user via the input device 204.

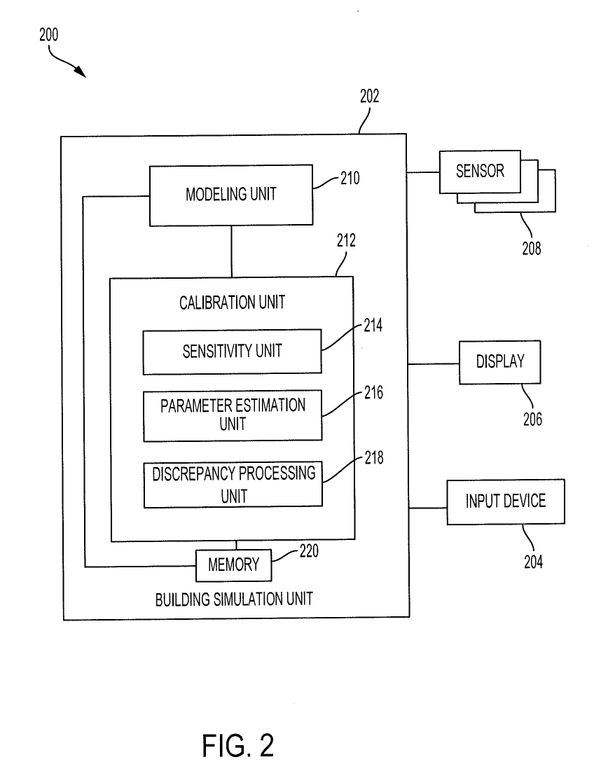

FIG. 3 illustrates an exemplary classification schema for input parameters for the building model. First the input parameters are classified into two categories: observable parameters and non-observable parameters. Observable parameters are the parameters, such as building window sizes and equipment multipliers, whose values could be determined directly using available evidence, such as evidence gathered through archived documents or on-site visits. The available evidence may be received by the building simulation unit 202 as building data. The building data may be provided by a user via the input device 204. Non-observable parameters, such as material conductivity and fan efficiency, may not be able to be determined by the available evidence.

The non-observable parameters are analyzed by sensitivity analysis. In some embodiments, the sensitivity unit 214 analyses the non-observable parameters. The sensitivity analysis is used to determine which of the parameters are influential. These influential parameters are differentiated and further categorized as estimable parameters and adjustable parameters.

Estimable parameters are the non-observable parameters that are deterministic in nature (e.g., door open/closed status) but whose values are difficult to collect due to lack of feasible data collection approaches or privacy concerns, for example, occupancy schedules. Estimable parameters may be indirectly inferred or calculated based on observable parameters by learning the relationships between estimable parameters and observable parameters. In some embodiments, the parameter estimation unit 216 calculates the values associated with the estimable parameters. The parameter estimation unit 216 may use the building data to calculate values associated with the estimable parameters.

Adjustable parameters, such as light radiant fraction, are parameters that are stochastic, or random, in nature. The values of these parameters are varied in their respective domains and may not be capable of being measured exactly. Adjustable parameters are further divided into significant adjustable parameters and insignificant adjustable parameters based on their statistical significance. The significant adjustable parameters are mainly responsible for the discrepancy between the simulated and measured energy performances. Their values are carefully determined for multi-level simulation calibration. The multi-level calibration may be defined as a calibration that minimizes discrepancies at different levels of simulation (e.g., building level, ECM level, and zone level). This classification may be used to define the characteristics and functions of each category for input parameters since building energy model calibration is a unique process.

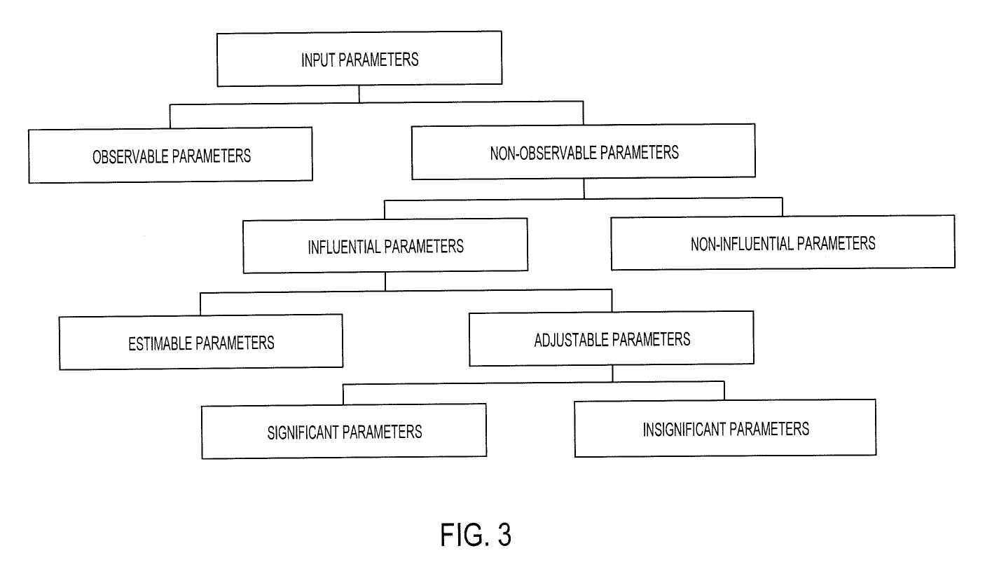

FIG. 4A illustrates a method of calibrating the building energy model. The method is generally based on: gathering data, constructing the model, simulating the model, analyzing and minimizing discrepancies between the simulated and measured energy performances. The method uses building data to build the energy model and implements statistical learning based on detected energy data to reduce the simulation discrepancy.

The process 400 begins with initial energy modeling (step 402). In some embodiments, the initial energy modeling is performed by the modeling unit 210. The initial energy modeling may include generating a building model of a particular building based on building data. The building data may be provided to the building simulation unit 202 via the input device 204 and saved in the memory 220. Some of the building data may be detected by the sensors 208.

Initial energy modeling provides a basic description for building geometry, construction elements, and mechanical systems, using evidence-based data. The initial representation of the building model may be created through iterative model evolution, where each input is updated based on a source of evidence. Since there may be various available sources for determining parameter values, a hierarchy structure may be used to rank evidence sources used to generate the building model. The source with higher priority is considered more reliable than the lower one.

In an example embodiment, the as-built documents and the design documents are evaluated first. The as-built and design documents may include architectural plans, electric lighting systems (e.g., lamps and ballasts), HVAC designs (e.g., zoning and connections), schedules (e.g., designed occupant schedules and light schedules), inventories (e.g., appliances and equipment), and HVAC specifications (e.g., fan nominal power). These as-built documents and design documents may part of the building data and used by the modeling unit 210 to generate the building model.

Next, in the example embodiment, the building is visited, building technicians, engineers, and building facility management personnel are surveyed and interviewed, and the operation and maintenance (O&M) manuals are studied. This survey and interview data may be input by the user via the input device, and the building data may be supplemented using this survey and interview data. The modeling unit 210 may determine a more accurate building model when the building data includes survey and interview data.

Some continuous measurements may be performed, such as lighting level, depending on specific building situations and available methods. The data previously collected is re-examined to check whether there is an update to be made or there is any change since the building was built. The sensors 208 may be used to detect environment data associated with the continuous measurements. The environment data may be used by the modeling unit 210 to determine a more accurate building model.

The last step in the example embodiment is using default settings based on similar types of buildings in simulation programs and using the codes and standards when needed. Although data from ASHRAE (American Society of Heating, Refrigerating and Air-Conditioning Engineers) standards and manufacturer handbooks may not be reliable due to the substantial variability in buildings and building systems, in some situations, values may be set for all input parameters to maintain model integrity.

A hierarchy of evidence sources may be determined. In the example embodiment, the sources providing continuous measurement of parameter values are most reliable, followed by the information gathered from surveying and interviewing building technicians, engineers, and building facility management personnel, followed by O&M manuals, followed by as-built documents, followed by design documents, followed by codes and standards, followed by default settings for similar types of buildings, which is the least reliable evidence source.

Since the available evidence for different buildings may have different levels of details and accuracies, the initial modeling may be an ad-hoc procedure, with numerous iterations of input value updates.

The initial building model is used as a basis for the sensitivity analysis (step 404). In some embodiments, the sensitivity unit 214 performs the sensitivity analysis. There may be as many as several hundred non-observable parameters whose exact values are unknown and it may be infeasible to run millions of simulations to determine the values of all of the non-observable parameters with an equal priority. Therefore, the number of non-observable parameters to be considered may be reduced. The influences of some input parameters on energy simulation results are more significant than others. Sensitivity analysis may be used as a screening method to rank non-observable parameters based on how the simulated energy performance changes in response to the changes made to each non-observable parameter. In some embodiments, in order to achieve accurate energy simulation results at multiple levels, when there are n levels of energy use, a sensitivity analysis is conducted n times.

While some screening methods are more accurate than others, any method may be used to identify the influential parameters. In some embodiments, the Morris method is used to identify the influential parameters. The Morris method makes no assumptions about the relationships (e.g., linearity and correlation) between parameters and model outputs, and it is capable of processing large numbers of parameters equally by a relatively limited number of simulation runs. This process is efficient and accurate as it does not require a predefined probability density function for each parameter, given the fact that assigning estimated probability density functions for hundreds of non-observable parameters is time-consuming and error-prone. Different parameter types (e.g., discrete, continuous or multi-dimensional) could be considered equally. Morris sensitivity analysis is based on the factorial sampling technique, in which the influential input parameters are identified through a series of simulation runs by changing one parameter at a time, and then comparing the corresponding simulated energy performances. A number of individual one-factor-at-a-time samples of input parameters are randomly generated within their ranges as an input vector for simulations.

Wide ranges of test values for each non-observable parameter may be used during the sensitivity analysis to increase the probability that the actual calibration value is within the range. Sensitivity of each parameter may be expressed by an elementary effect value, which is defined as the measure of parameter influence, showing the change in the simulation output as a result of a change in this parameter, while all other parameters are kept constant. As the value of each parameter is varied within its range, the mean value of the effect m is compared to the standard deviation S_{d} to provide a normalized criterion for ranking influential parameters. Parameters with higher absolute mean-standard deviation ratio are more influential. The boundary between influential parameters and non-influential parameters may be determined case by case based on different goals, computational requirements and result distributions. In some embodiments, if the parameters are above the threshold set by the lines m=±2S_{d}/\sqrt{r} is the number of independent samples for each parameter), they are considered to have non-linear or joint effects.

A parametric comparison is performed to identify the estimable parameters and to identify the adjustable parameters from the influential parameters (step 406). As described herein, the estimable parameters are those capable of being estimated based on the building data. Adjustable parameters are stochastic in nature and not capable of being reliably predicted, only statistically analyzed.

Parameter estimation is conducted for the influential non-observable parameters that are deterministic in nature (e.g., estimable parameters), but are difficult to be collected due to lack of feasible data collection approaches (step 408). These estimable parameters may be building use related (e.g., occupancy, lighting, and appliance) or system operations related (e.g., HVAC thermostat schedules). Occupancy is a significant reason for the discrepancies between the simulated and measured energy performances, as the main end-users of energy, such as HVAC systems, lighting and appliances are associated with occupancy. Day-typing (typical days to characterize a period of time), zone-typing (typical space to represent a building), observations, surveys, short-term measurements, or real-time end use monitoring methods may be used to collect data. However, these methods may not be practical due to the intrusion they cause to buildings and their occupants, and they do not satisfy the requirements for detailed building energy simulation because of the lack of precision and consistency and verification in auditing.

Instead, some of the estimable parameters may be indirectly inferred or calculated from the observable parameters. The parameters to be estimated may either have regular influences on certain observable parameters or their values may repetitively occur with variations. Therefore, the relationships between estimable parameters and observable parameters could be established through statistical learning. Use of statistical learning may result in an association between a particular estimable parameter and one or more observable parameters, such that given one or more respective values of the one or more observable parameters, a value for the estimable parameter may be determined.

Once completed, measurements of observable parameters (depending on the sophistication of building management systems and types of onsite metering systems) are learned as parameter values for estimable parameters. If there are common parameters shared by various levels, they are assigned with the same values. In some embodiments, ECM-related parameters may be controlled instead of being estimated.

In general, lack of necessary evidence, for determining the input parameters, is common in building energy simulation and that is one of the motivations for the systems and methods described herein. Evidence capable of being directly determined should be used and provided to the base modeling (or updated building model) (step 410). For those parameters that cannot be determined directly by evidence, values are first assigned as default values or autosized by the parameter estimation unit 216. Once the new values are calculated by the calibration unit 212, the new values may be provided to the base modeling and used to update the temporary values set in the initial modeling (step 410).

Some of the adjustable parameters may be responsible for the majority of the discrepancies between the simulated and measured energy performances. Accordingly, the structural patterns of the discrepancies are explored, and insignificant parameters are screened out.

For each adjustable parameter, distribution analysis is performed (step 412). Initially, a linear relationship may be used to model the contribution of each adjustable parameter to the discrepancies using a regression fitting. All adjustable parameters are varied within their ranges and the nominal values are their default values that could be found in simulation programs. A probability density function (e.g., triangular, Gaussian, or uniform) of each continuous parameter, such as wind speed, is used to select the values based on its probability distribution, while discrete parameters such as iteration number are characterized by minimum, maximum and default values. In some embodiments, the building simulation unit 202 automatically performs the distribution analysis to determine ranges of the parameters. Each parameter is normalized for comparison. In some embodiments, each parameter is normalized using the formula

$${x}^{*} = \frac{x - {x}_{min}}{{x}_{max} - {x}_{min}} ( {x}_{max}^{*} - {x}_{min}^{*} ) + {x}_{min}^{*} .$$

A discrepancy analysis is performed (step 414). In some embodiments, random sampling is used to select samples to form independent variables, and multiple simulation runs are then completed to generate the output vector. Detected energy data associated with actual energy use in the building may be provided (step 416). As described herein, the detected energy data may be provided by the user via the input device 204. The discrepancies between the simulated and measured energy performances (provided by the detected energy data) calculated by dividing the difference between the simulated results and the actual measurements by the actual measurements, are used as dependent variables. The values of remaining parameters (after parameter estimation is completed) are considered as independent variables. The number of simulation runs may be based on experience or trial. In some embodiments, the number of simulation runs depends on when the regression model converges. Specifically, multi-regression is used to establish the linear model, the outputs (discrepancies) of which are the sums of combinations of parameter values, while the weights are assigned to each parameter before adding them together.

The regression line used in the discrepancy analysis may be denoted by yₗₑᵥₑₗₙa+b₁x₁+b₂x₂+b₃x₃+ . . . +bₖxₖ+ε, where a is the intercept, ε is the random disturbance and b₁ is the coefficient of the ith parameter, indicating its contribution to the determination of the dependent variable. If some of the parameters are proven to be interrelated as a result of the sensitivity analysis, the linear model is modified into a non-linear one. For example, if parameter x₁, x₂, x₃ are all above the

$$m = \pm \frac{2 {S}_{d}}{\sqrt{r}}$$

lines (where m is the mean of its elementary effects, S_{d} is the standard deviation of its elementary effects, and r is the number of samples selected), the new multi-regression model may be yₗₑᵥₑₗₙ=a+b₁x₁+b₂x₂+b₃x₃+b′₁x₁x₂+b′₂x₂x₃ +b′₃x₁x₃+b′₄x₁x₂x₃+b₄x₄+ . . . +bₖxₖ+ε to take their interactions into consideration.

In order to calibrate the energy model at multiple levels, n (n equals to the number of levels) multiple-regression models may be created simultaneously, in which some of the parameters might be shared. The same parameters could have different weights or even reverse contributions (overestimate or underestimate) to different levels of simulations. The intercepts and coefficients of variables may be estimated with the least square method, and coefficients of determination (R̅²̅) may be calculated to interpret the proportions of discrepancies that can be explained by the regression models. F-statistics may be used to test the significance of the regression models and to analyze whether the discrepancies are significantly influenced by the adjustable parameters. Then T-statistics may be used to differentiate insignificant parameters from significant parameters, which account for the discrepancies.

After identifying the contributions of parameters to the simulation discrepancies at different levels, the values of these parameters for minimizing the discrepancies at multiple levels simultaneously is determined (step 418). Conventionally, the values of the significant adjustable parameters may be determined as manual inputs of the user, using the user's subjective judgment. In many cases, the user's subjective judgment results in best-guesses or blind adjustment. In order to make this step more efficient and repeatable, multi-objective programming is used for updating the values of adjustable parameters and minimizing the simulation discrepancies at multiple levels simultaneously. The multi-objective may be denoted by min={y′_{Level1}, y′_{Level2}, y′_{Level3}, . . . , y′_{Leveln}}, subject to the constraints, such as bound limits and integrality requirements. Since the values of all parameters should be selected from their parameter ranges and are recommended not to be far from the default values set by the program, the objective functions are expressed as y′ₗₑᵥₑₗₙ=a+b₁x₁+b₂x₂+b₃x₃+ . . . bₖxₖ+ε′Σ₁^{k}(xₖ−x_{k default})² (both xₖ and x_{k default} are normalized by

$${x}_{k or k default}^{*} = \frac{{x}_{k or k default} - {x}_{min}}{{x}_{max} - {x}_{min}} ( {x}_{max}^{*} - {x}_{min}^{*} ) + {x}_{min}^{*}$$

where a penalty is introduced).

Initially, each single objective function may be solved independently. In some embodiments, pareto optimal solution sets A* (for minimizing discrepancies at the level 1), A** (for minimizing discrepancies at the level 2), and so forth, are generated separately for multiple objectives. The union of A*, A** and so forth, is the solution set for the multi-objective programming. The relative importance of the n objectives should be carefully selected based on the purpose of simulation, as the selected weights have significant influences on the final solution. If the weights are arbitrarily assigned, the programming may converge on the locally optimal solution. Therefore, the weight computation process may be a synthetical fitness optimization problem with preference being considered as a constrain condition. The relative importance of w₁⁰ (for level 1 accuracy) and w₂⁰ (for level 2 accuracy), and so forth (e.g., w₁⁰>w₂⁰>w₃⁰>w₄⁰ . . . wₙ⁰) may be determined. A gradient projection method may then be used to search the optimal weights that could maximize weighted variance and differentiate each solution from others. Once the weights are decided, they are assigned to all objectives, and the multi-objective is converted into a single weighted objective function as min f={w₁⁰y_{Level1}+w₂⁰y_{Level2}+w₂⁰y_{Level3}+ . . . +w_{Leveln}}, where w₁⁰+w₂⁰+w₃⁰+w₄⁰+ . . . +wₙ⁰=1.

Linear programming may then be used to synergize the weights of parameters at each level determined by regression analysis and find the initial solutions (seed vertex). An effective vertex near the seed vertex is also searched. As long as the actual disaggregated energy performance for detailed end uses, such as lighting, equipment, and HVAC, could be metered, the multi-objective discrepancy minimization method could be applied to any multiple-level calibration.

Once the input parameters which minimize discrepancies are determined, the determined input parameter values may be incorporated into the building model to provide a calibrated building model for simulating energy used by the building (step 422). The calibrated building model may be evaluated using detected energy data (step 420).

FIG. 4B illustrates an exemplary process 450 of calibrating the building energy model.

A building model is generated by a modeling unit 210 (step 452). The modeling unit 210 generates the building model based on building data associated with the building. The building model may have a plurality of levels each representing a scope of energy use, and the building model may simulate energy use in the building based on one or more values corresponding to one or more input parameters to produce building model simulation results.

A detected energy data is received by the calibration unit 212 (step 454). The detected energy data (or ground truth data) may represent actual energy use in the building over a period of time. One or more sensors 208 may be used to detect the detected energy data.

One or more observable parameters are identified from the one or more input parameters by the calibration unit 212 and one or more respective values for the one or more identified observable parameters are determined based on the building data (step 456).

A sensitivity analysis is performed by the sensitivity unit 214 on the portion of the one or more input parameters which are not identified as being observable parameters (e.g., non-observable parameters) (step 458). The sensitivity analysis results in identification of one or more influential parameters from the one or more input parameters. The sensitivity analysis may be performed using the building model. The sensitivity unit 214 may rank the input parameters by impact of a change of a particular parameter on the simulated energy use in the building. In some embodiments, only the portion of the one or more input parameters which are not identified as being observable parameters are considered and ranked.

The sensitivity unit 214 may identify a portion of the ranked input parameters as being influential parameters. In some embodiments, a threshold number of the input parameters which most affect the simulated energy use in the building are identified as being influential parameters. In some embodiments, all input parameters exceeding a threshold influence value (e.g., elementary effect) are identified as being influential parameters.

A discrepancy analysis is performed by the discrepancy processing unit 218 on the influential parameters to identify one or more adjustable parameters from the influential parameters (step 460). The discrepancy processing unit 218 may determine a simulated energy use for various random test values of each parameter from the one or more influential parameters using the building model. The discrepancy processing unit may then compare the simulated energy use with actual energy use based on the detected energy use to identify the one or more adjustable parameters.

The influential parameters which are not adjustable parameters are estimable parameters. One or more estimable parameters are identified and one or more respective values for the one or more identified estimable parameters are determined by the parameter estimation unit 216 based on the one or more respective values for the one or more observable parameters, as determined in step 456 (step 462).

Values of the identified one or more adjustable parameters are determined by the discrepancy processing unit 218 (step 464). In some embodiments, a portion of the adjustable parameters is identified as being significant adjustable parameters, and those significant adjustable parameters are analyzed to determine values, as described herein. The discrepancy processing unit 218 may use multi-objective programming to determine the values of the adjustable parameters which minimize discrepancies at the plurality of levels.

The determined values of the adjustable parameters are incorporated into the building model to provide a calibrated building model for simulating energy use in the building (step 466). In some embodiments, the determined values are a set of values and identifiers, and the set of values and identifiers is provided by the calibration unit 212 to the modeling unit 210, and the modeling unit 210 incorporates the values into the building model.

The systems and methods described herein provide an improvement to the existing technology of simulating energy use by a building model. Previously, building models were subject to inaccuracies between the simulated energy use and actual observed energy use because a number of input parameters were not accurately determined. Previously, the process relied on human subjective judgment to determine the values of these input parameters. The reliance on human subjective judgment resulted in errors in the building model being able to accurately simulate the energy use of the building. Simulating building energy use was not a process previously capable of being performed without a computer. There are many factors and complex calculations performed in simulating building energy use, and it is not a process capable of being performed by a human mind. Accordingly, the systems and methods described herein provide a solution necessarily rooted in computer technology to overcome a problem specifically in the realm of building energy use simulations.

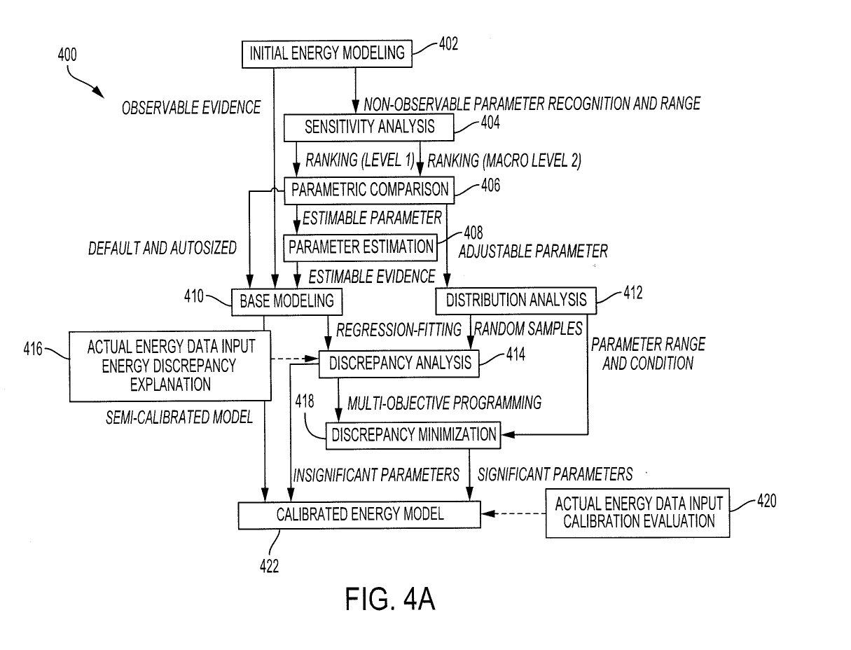

FIG. 5 shows an exemplary user interface 500 for interacting with the building simulation unit 202. The user interface 500 may be displayed by display 206.

The user interface 500 includes a model input field 504. The building model may be stored in the memory 220 and the model input field may identify a file location of the building model. The user interface 500 also includes a ground truth (or detected energy data) input field 506. The ground truth data (or detected energy data) may be stored in the memory 220 and the ground truth input field 506 may identify a file location of the ground truth data. The ground truth data may be saved as a spreadsheet, in some embodiments. The user interface 500 includes an existing building model search field 508. The user may search for existing building models saved in the memory 220 using the existing building model search field 508.

The user interface 500 includes a synchronize icon 510. When the user clicks on the synchronize icon 510, the building model and the detected energy data is synchronized. The building model and the detected energy data may both be dependent on time, and by clicking on the synchronize icon 510, the building model and the detected energy data are synchronized based on time.

The user interface 500 includes a level identification section 512. The user may identify one or more levels to be considered when the calibration unit 212 calibrates the building model. The user interface 500 also includes a sensitivity analysis identification section 514, where the user may identify a sensitivity analysis criteria to be used when the sensitivity unit 214 performs the sensitivity analysis. The user interface 500 also includes a discrepancy analysis identification section 516, where the user may identify a discrepancy analysis criteria to be used when the discrepancy processing unit 218 performs the discrepancy analysis. The user interface 500 also includes an optimization method identification section 518, where the user may identify an optimization method criteria to be used when the discrepancy processing unit 218 determines values for the adjustable parameters.

Tabs 522 allow the user to toggle between the various types of input parameters. In some embodiments, only the significant adjustable parameters are displayed. Each input parameter may have a name 528, a range of values 530, a particular value 532, and an autosize indicator 534. When the autosize indicator 534 is checked, a range and/or value may be automatically determined by the system.

A graph 524 illustrates discrepancies between the building model and the ground truth input data given the values of the significant adjustable parameters. When the update icon 526 is clicked, the graphs update based on the values of the significant adjustable parameters.

When the calibrate icon 520 is clicked, the building model identified in the model input field 504 is synchronized using the provided detected energy data identified in the ground truth input field 506, across the levels identified in the level identification section 512, according to the sensitivity analysis criteria identified in the sensitivity analysis identification section 514, the discrepancy analysis criteria identified in the discrepancy analysis identification section 516, and the optimization method criteria identified in the optimization method identification section 518.

When the reset icon 536 is clicked, all of the fields in the user interface 500 are cleared, and when the export icon 538 is clicked, a calibrated building model is generated. In some embodiments, the calibrated building model is saved in memory 220. In some embodiments, the calibrated building model is provided on the display 206 for the user to run simulations with. In some embodiments, the calibrated building model has a same file extension as the provided building model identified in model input field 504.

An experimental building model and calibration was performed according to the systems and methods described herein. In experiment, an office in Los Angeles was modeled, and the model was calibrated according to the systems and methods described herein. The example building is a three-story office building with a gross area of 3,735 square meters, and contains 89 mechanically ventilated rooms that have spaces of varying sizes and functions. Most of the rooms in the building are enclosed single occupancy offices; other rooms are classrooms, conference rooms, and auditoriums. The building hosts approximately 50 permanent occupants (e.g., staff, faculty, graduate students). The building is equipped with a Building Management System (BMS) and central HVAC system with air handling units (AHU). A zone was defined as the mechanical zones for the HVAC system. The 89 rooms are divided into 67 mechanical zones, including 64 variable air volume (VAV) controlled zones and 3 fan-coil controlled zones. The heat flow and ventilation of each zone can be individually controlled and adjusted. There are two AHUs in the building, each servicing one side of the building with similar sizes of service areas.

The HVAC energy consumption in the building can be decomposed to primary HVAC systems, such as used by chillers and boilers to generate chilled and hot water, secondary HVAC systems, such as used by AHUs and their embedded fans to distribute conditioned air in the building, and HVAC terminals, such as VAVs and fan coil units (FCUs). The ground truth energy data used for calibration was obtained or calculated from the information recorded by the BMS, which provides central control over the chiller, boiler, AHUs and VAVs. This information typically includes AHU damper position, fan flow rate, outside temperature, VAV damper position, supply air temperature, return air temperature, and so on.

In the experiment, two different ECMs (HVAC control strategies) were implemented in the building. The energy model was calibrated according the methods described herein using ground truth energy data from mixed ECMs and consistently simulated energy performance for either ECM. The first ECM (baseline HVAC control strategy, short as “baseline ECM”) was run at an on-hour mode during the daytime (6:30-21:30 on weekdays, and 7:00-21:30 on weekends), all mechanical zones in the building are assumed to be always occupied, and a constant temperature setpoint (22.8 degrees C.) was maintained by a Proportional Integral Derivative (PID) controller, which dynamically adjusted the airflow damper and reheating valve of each zone. The second ECM (bimodal HVAC control strategy, short as “bimodal ECM”) was demand responsive and based on real-time occupancy. During the daytime, an occupied mode was enforced for occupied zones, where a constant temperature setpoint (22.8 degrees C.) was maintained by the PID controller. If a zone was vacant for a minimum of 15 min, a vacant mode was enforced, where the temperature setpoint was set back to 25.5 degrees C. until the zone was occupied again. The bimodal ECM was implemented on the east side of the second and third floors covering 37 rooms (14 zones of which were metered by the BMS). The rest of the building was operated using the baseline ECM. Both ECMs had off-hour modes, where the HVAC system was shut off during nighttime, and no cooling, heating or ventilation services were provided. Only minimum airflow was maintained to meet the ASHRAE compliance. Four months of energy consumption data were collected during these two periods. The first period spanned for 82 days from January 1st to Feb. 21, 2013 and from April 1st to Apr. 30, 2013, and the HVAC system during this period was operated under baseline ECM. The second period spanned for 38 days from February 22nd to Mar. 31, 2013, when the bimodal ECM was adopted for the 14 zones.

In the experiment, HVAC related energy consumption was simulated. While the calibration is evaluated at three different levels (i.e., building level, ECM level and zone level energy simulation calibration), the discrepancy minimization could be applied to any multiple levels of calibrations, such as floor level. A total of 22 zones and HVAC chiller, boiler and AHUs were taken into account for validation. Metrics were defined to explore the discrepancies between the simulated and measured HVAC energy consumptions at three different levels. For the building level calibration, the sum of electricity and gas consumed by the entire HVAC system, including the air loops and plant loops, was compared with the measured consumption to indicate the percentage of building level discrepancy. Energy consumption of each zone for each day, including heating and cooling provided by the terminals for actual conditioning demands, was calculated by a heat formula Qᵢ=˜^{ρ}\dot{V}Cₚᵢ|Tₛᵢ−Tᵣᵢ| where Tₛᵢ and Tᵣᵢ are supply air temperature and return air temperature for zone i, and \dot{V} is the air volume flow rate (m²/s). Their actual values are metered and recorded by BMS. Cₚᵢ is a constant value of specific heat capacitance for zone air as 1000 J/(kg ° C.) and ρ is the zone air mass density with the value of 1.29 kg/m³. Zone level ventilation was not considered in this experiment due to the lack of metered data.

The ECM level energy consumption was calculated by adding the energy consumptions of the zones served by one AHU, according to Q̅=Σᵢ¹⁴Qᵢ. The AHU takes in outside air, mixes it with returned air from the building, and cools down the mixed air to 12.8° C. with chilled water supplied by the chillers. There are 14 zones on the east side of the second and third floors, where both the baseline ECM and bimodal ECM were implemented. The zone level energy consumption was calculated by averaging the energy consumptions of 8 zones on the west side of the third floor where only baseline ECM was implemented, according to Q̅=⅛Σᵢ⁸Qᵢ. The MBE (mean bias error) and CV (RMSE) (coefficient of variation of the root mean squared error) widely used in previous research were chosen as two criteria to evaluate the calibrated energy model by checking whether there is acceptable agreement between the simulated and measured energy consumption. Hourly calibration was conducted. N stands for the number of hours within a period. E_{actual} is the actual energy consumption metered by the BAS while E_{simulated} is the simulated energy consumption by the building energy model according to

$$M B E = \frac{{\sum }_{j = 1}^{N} ( {E}_{actual ( j )} - {E}_{simulated ( j )} )}{N} and$$

$$C V ( R M S E ) = \frac{\sqrt{{\sum }_{j = 1}^{N} {( {E}_{actual ( j )} - {E}_{simulated ( j )} )}^{2}}}{\overline{E}} .$$

MBE is a non-dimensional bias measure for overall deviation. A negative MBE value means the simulation model underestimates the energy consumption, while a positive MBE value represents an overestimation. It could measure long-term model performance through analyzing the error between the simulated and measured energy consumptions; however the underestimation and overestimation might compensate each other. The averaged sum of squares errors is called the mean squared error (MSE). CV(RMSE) is determined by dividing the RMSE by the mean measured energy consumption. It is not influenced by the compensation effect and could evaluate the variability of agreement between the simulated results and measured values over a period of time. In general, an energy simulation model is considered as calibrated if the two criteria are satisfied at all the three levels according to the acceptable tolerances set by ASHRAE Guideline 14, IPMVP or FEMP. As there is no regulated daily tolerance in literature, in this case study, hourly tolerances, as shown in Table 1 were used for evaluating daily MSE and CV (RMSE).

TABLE 1

| Metric | IPMVP (%) | FEMP (%) | ASHRAE (%) |
|---|---|---|---|
| MBE | ±5 | ±10 | ±0 |
| CV (RMSE) | ±20 | ±30 | ±30 |

The initial energy model, for the case study, incorporated information collected from archived documentations, such as as-built drawings, specifications, renovation logs, operating records, and information gathered from on-site visits, where building's geometric characteristics, construction elements, associated mechanical systems, appliance specifications, were collected. For the rest of the input parameters that did not have available evidence, default settings were used or their values were temporarily assigned according to standards and codes. Weather was modeled using TMY (Typical Meteorological Year) data downloaded from the DOE website (Energy Efficiency and Renewable Energy) specific for the building site. The data were collected from the station close to Los Angeles International Airport that is about 10 miles away from the test bed building. The TMY are data sets of hourly values of meteorological elements and solar radiation for one year. The simulation period spanned from January 1st to Apr. 30, 2013, and from March 15th to November 15, 2014.

In total, there were 227 parameters whose values could not be determined (non-observable parameters) during the initial energy modeling due to the lack of available evidence, such as surface albedo, fan total efficiency and air flow fraction. Morris method was implemented three times for the building level, ECM level and zone level sensitivity analysis. The elementary effect was expressed as a percentage of simulation variation in response to the change resulting from the variation of the input parameter. For each parameter, five independent samples (r=5) were randomly selected and the elementary effects were simulated by EnergyPlus with 1362 simulation runs (the number of runs=(r+1)/the number of parameters) in total for each level. The sensitivity analysis has been implemented using Matlab. The 1362 idf files were generated for simulation runs and the simulation results (from Energyplus) were collected to calculate the elementary effect for each parameter. The parameters were then ranked by their absolute mean-standard deviation ratios and the ones with higher ratios were considered as more influential for the energy simulation.

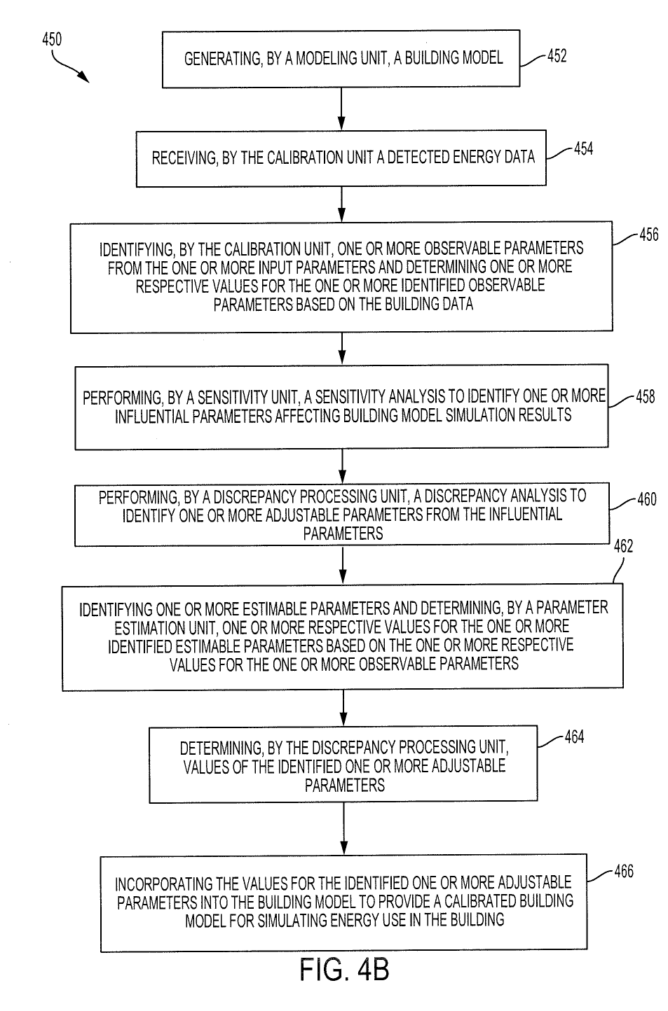

Conservative boundary was set, by which the parameters with absolute mean-standard deviation ratio greater than 0.1 were influential (the boundary could also be determined by experience or using visual plot). FIG. 6 shows the mean and standard deviation of the elementary effects for each parameter. 34 parameters for building level simulation, 32 parameters for ECM level simulation and 33 parameters for zone level simulation were presented in a decreasing order of influence shown in Tables 2a-2c, respectively. The influential parameters for the three levels of energy simulation were not exactly the same; even the common parameters had different orders of influence. As expected, building level influential parameters had global influence on the building energy consumption, basically related to running controls and loads for HVAC systems, conditions and performance for HVAC plants, and envelope thermal characteristics; ECM level influential parameters had influences on local thermal states, loads, control settings and conditions for HVAC terminals; zone level influential parameters were mainly associated with end use demands, material properties, space heat transfer and balance. The three lists of parameters should be given primary focus by changing the values of the influential parameters within their plausible parameter ranges in the next steps. The noninfluential parameters were left with their default values or autosized by EnergyPlus.

For the experiment, the tested hypothesis was that the parameters related to building use or system operations are associated with occupancy. The heating/cooling schedule, lighting schedule, equipment schedule, occupant number, lighting load and occupant heat load could be related to occupancy schedule. First, two on-site visits were performed to collect the information about the occupancy capacity of each zone and the specifications and number of computers and appliances in each zone. It has been demonstrated by the authors' previous research that occupancy schedules could be estimated by a real-time non-intrusive occupancy detection model using the observable ambient related parameters, such as CO2 concentration, temperature and light level. The underlying assumption is that occupancy status regularly influences the ambient environment. Thus, there exists a relationship between presence of an occupant and changes in the ambient factors, where an occupant is present. By mathematically or statistically modeling this relationship through supervised learning, future ambient data could be analyzed to output corresponding occupancy status. The sampling rate for the occupancy detection model was 3 min. Schedules for rooms without ambient sensors were determined according to the ANSI/ASHRAE/IES Standard 90.1-2013.

Equipment/appliances were assumed to be only used when a space was occupied thus their schedules followed occupants' schedules. Lighting levels were sensed by light sensors in each room. Light fixtures were assumed to be used if a space was occupied and when artificial lighting was needed during 6:30-10:00 and 15:30-18:00 (after 18:00 lighting schedules were the same as the occupancy schedules). The parameter for occupant heat load was calculated based on the occupant number at each time point and based on the standards specified by the ASHRAE 2009. The exceptional parameters controlled were for the two ECMs of HVAC setpoint controls and are presented in Tables 2a-2c. The two parameters of HVAC Setpoints and Heating/ Cooling Schedules for the 14 zones during the bimodal ECM implementation period were programmed and driven by actual occupancy; otherwise they followed the baseline ECM. Occupancy of a particular zone was determined by aggregating the occupancy of associated rooms. A zone was considered vacant only if all rooms within the zone were vacant.

TABLE 2a

| IDs | Influential Parameters | Parameter Ranges | | Default Value |
|---|---|---|---|---|
| 1 | Chiller COP | 0 < | X < 10 | 5.9 |
| 2 | Wind Speed | 0 <= | X < 40 | 15 |
| 3 | Occupant Activity | 100 <= | X <= 150 | 115 |
| 4 | Heating/Cooling Schedule | ECM Control | | TBD |
| 5 | Chilled Water Delta T | −50 <= | X <= 50 | 14 |
| 6 | Solar Absorptance | 0 <= | X <= 1 | 0.7 |
| 7 | Material Conductivity | 0 < | X < 30 | 17 |
| 8 | Occupancy Schedule | Estimable | | TBD |
| 9 | Lighting Fraction Radiant | 0 <= | X <= 1 | 0.72 |
| 10 | Surface Albedo | 0 <= | X <= 1 | 0.3 |
| 11 | Fan Total Efficiency | 0 <= | X <= 1 | 0.7 |
| 12 | Light Schedule | Estimable | | TBD |
| 13 | Temperature Sensor Height | 0 <= | X <= 3 | 1.6 |
| 14 | Occupancy Time Interval | 0 <= | X <= 60 | 10 |
| 15 | Solar Heat Gain Coefficient | 0.25 <= | X <= 0.8 | 0.5 |
| 16 | Hot Water Sizing Factor | 0 < | X < 5 | 1 |
| 17 | Wall U-Factor | 0.2 <= | X <= 1.2 | 0.8 |
| 18 | Equipment/Appliance Schedule | Estimable | | TBD |
| 19 | Average Ventilation Rate Range | 1 <= | X <= 6 | 4 |
| 20 | Chiller Part Load Ratio | 0.3 <= | X <= 0.9 | 0.7 |
| 21 | Boiler Efficiency | 0 <= | X <= 1 | 0.8 |
| 22 | Heating/Cooling Time Interval | 0 <= | X <= 60 | 10 |
| 23 | Occupant Heat Load | Estimable | | TBD |
| 24 | AHU Minimum Airflow Rate | 0 < | X < 25000 | 15000 |
| 25 | Heat Recovery Efficiency | 0 <= | X <= 1 | 0.8 |
| 26 | Fresh Air Introduction Rate | 20 <= | X <= 50 | 35 |
| 27 | Maximum Zone Wind Speed | 0 <= | X < 40 | 20 |
| 28 | Minimum Outside Air Fraction | 0 <= | X <= 1 | .3 |
| 29 | Airflow Convergence Tolerance | 0 < | X < 1 | 0.0004 |
| 30 | Lighting Time Interval | 0 <= | X <= 60 | 10 |
| 31 | Ground Temperature | 66 <= | X <= 72 | 68 |
| 32 | Minimum Surface Convection | 0 <= | X <= 5 | 3 |
| | Heat Transfer Coefficient | | | |
| 33 | Ground Reflectance | 0 <= | X <= 1 | 0.2 |
| 34 | Reference Barometric Pressure | | X > 0 | 1 * 10⁵ |

TABLE 2b

| | | | | Default |
|---|---|---|---|---|
| IDs | Influential Parameters | Parameter Ranges | | Value |
| 1 | Zone Cooling Sizing Factor | 0 <= | X <= 5 | 1.1 |
| 2 | Thermostat Setpoint | ECM Control | | TBD |
| 3 | Minimum Airflow Fraction | 0 <= | X <= 1 | 0.2 |
| 4 | Heating/Cooling Schedule | ECM Control | | TBD |
| 5 | Temperature Sensor Height | 0 <= | X <= 3 | 1.6 |
| 6 | Occupancy Schedule | Estimable | | TBD |
| 7 | Heating Coil Efficiency | 0 <= | X <= 1 | 0.8 |
| 8 | Zone Supply Air Temperature | 10 <= | X <= 32 | 20 |
| 9 | Solar Heat Gain Coefficient | 0.25 <= | X <= 0.8 | 0.5 |
| 10 | Wall U-Factor | 0.2 <= | X <= 1.2 | 0.8 |
| 11 | Delta Adjacent Zone Temp | −20 <= | X <= 20 | 10 |
| 12 | Occupant Number | Estimable | | TBD |
| 13 | Heating/Cooling Time Interval | 0 <= | X <= 60 | 10 |
| 14 | Supply/Zone Air Temperature Delta | −20 <= | X <= 20 | 6 |
| 15 | Daily Temperature Range | −20 <= | X <= 20 | 10 |
| 16 | Lighting Schedule | Estimable | | TBD |
| 17 | Window Shading Coefficient | 0.2 < | X < 1.0 | 0.8 |
| 18 | Fraction of Convective Internal Loads | 0 <= | X <= 1 | 0.7 |
| 19 | Occupant Heat Load | Estimable | | TBD |
| 20 | Airflow Convergence Tolerance | 0 < | X < 1 | 0.0004 |
| 21 | Lighting Load | Estimable | | TBD |
| 22 | Zone Flow Coefficient | 0 <= | X <= 1 | 0.8 |
| 23 | Thermal Absorptance | 0 < | X < 0.999 | 0.9 |
| 24 | Infiltration Rate | 0.1 < | X <= 5 | 1.8 |
| 25 | Gross Rated Cooling Coil COP | 0 < | X < 5 | 3 |
| 26 | Equipment/Appliance Schedule | Estimable | | TBD |
| 27 | Effective Air Leakage Area | 0 < | X < 50 | 20 |
| 28 | Light Fraction Radiant | 0 <= | X <= 1 | 0.72 |
| 29 | Maximum Zone Wind Speed | 0 <= | X <= 40 | 20 |
| 30 | Internal Loads Density | 1.5 <= | X <= 3 | 1.8 |
| 31 | Window Solar Transmittance | 0 <= | X < 1 | 0.7 |
| 32 | Visible Absorptance | 0 <= | X <= 1 | 0.7 |

TABLE 2c

| | | | | Default |
|---|---|---|---|---|
| IDs | Influential Parameters | Parameter Ranges | | Value |
| 1 | Solar Heat Gain Coefficient | 0.25 <= | X <= 0.8 | 0.5 |
| 2 | Sensible Heat Ratio | 0.5 <= | X <= 1 | 0.8 |
| 3 | Wall U-Factor | 0.2 <= | X <= 1.2 | 0.8 |
| 4 | Supply-Air-to-Zone-Air Temperature | −20 <= | X <= 20 | 6 |
| | Difference | | | |
| 5 | Zone Flow Coefficient | 0 <= | X <= 1 | 0.8 |
| 6 | Heating/Cooling Schedule | ECM Control | | TBD |
| 7 | Fresh Air Introduction Rate | 20 <= | X <= 50 | 35 |
| 8 | Thermostat Setpoint | ECM Control | | TBD |
| 9 | Zone Cooling Sizing Factor | 0 <= | X <= 5 | 1.1 |
| 10 | Temperature Sensor Height Above | 0 <= | X <= 3 | 1.6 |
| | Ground | | | |
| 11 | Occupancy Schedule | Estimable | | TBD |
| 12 | Occupant Number | Estimable | | TBD |
| 13 | Delta Adjacent Zone Temp | −20 <= | X <= 20 | 10 |
| 14 | Lighting Schedule | Estimable | | TBD |
| 15 | Minimum Surface Convection Heat | 0 <= | X <= 5 | 3 |
| 16 | Airgap Thermal Resistance | | X > 0 | 0.2 |
| 17 | Glazing Conductivity | | X > 0 | 0.9 |
| 18 | Heating/Cooling Time Interval | 0 <= | X <= 60 | 10 |
| 19 | Equipment/Appliance Schedule | Estimable | | TBD |
| 20 | Minimum Airflow Fraction | 0 <= | X <= 1 | 0.2 |
| 21 | Occupant Heat Load | Estimable | | TBD |
| 22 | Zone Supply Air Temperature | 50 <= | X <= 90 | 68 |
| 23 | Occupant Activity | 100 <= | X <= 150 | 115 |
| 24 | Delta Adjacent Zone Air Temperature | −20 <= | X <= 20 | 10 |
| 25 | Daily Temperature Range | −20 <= | X <= 20 | 10 |
| 26 | Solar Transmittance | 0 < | X < 1 | 0.7 |
| 27 | Airflow Convergence Tolerance | 0 < | X < 1 | 0.0004 |
| 28 | Visible Reflectance | 0 <= | X <= 1 | 0.08 |
| 29 | Infiltration Rate | 0.1 < | X <= 5 | 1.8 |
| 30 | Light Fraction Radiant | 0 <= | X <= 1 | 0.72 |
| 31 | Surface Albedo | 0 < | X <= 1 | 0.3 |
| 32 | Internal Loads Density | 1.5 <= | X <= 3 | 1.8 |
| 33 | Lighting Time Interval | 0 <= | X <= 60 | 10 |

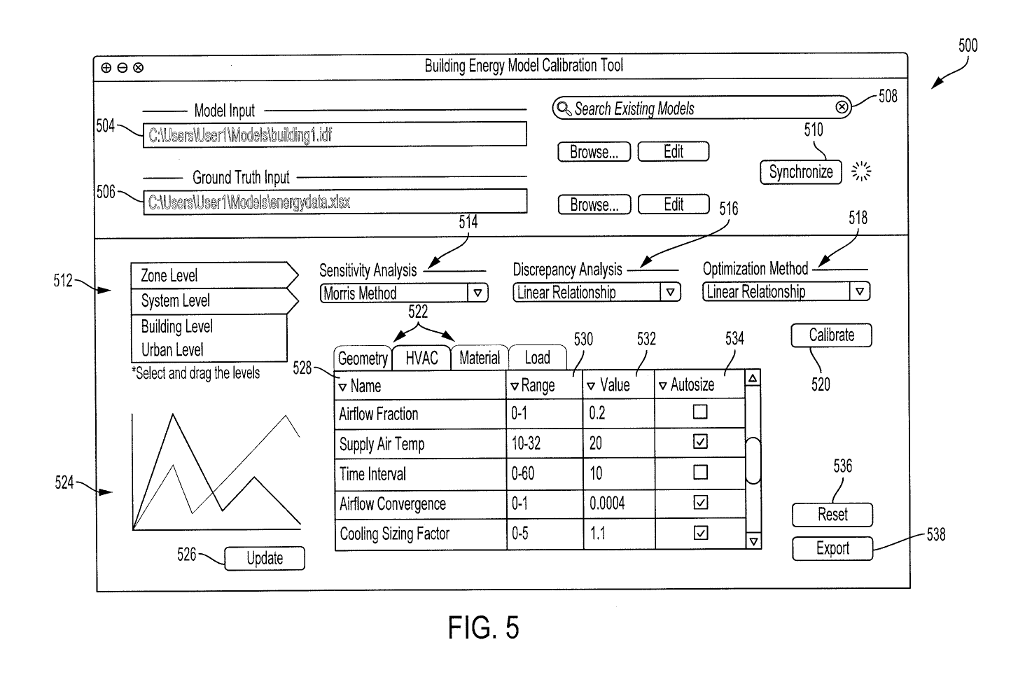

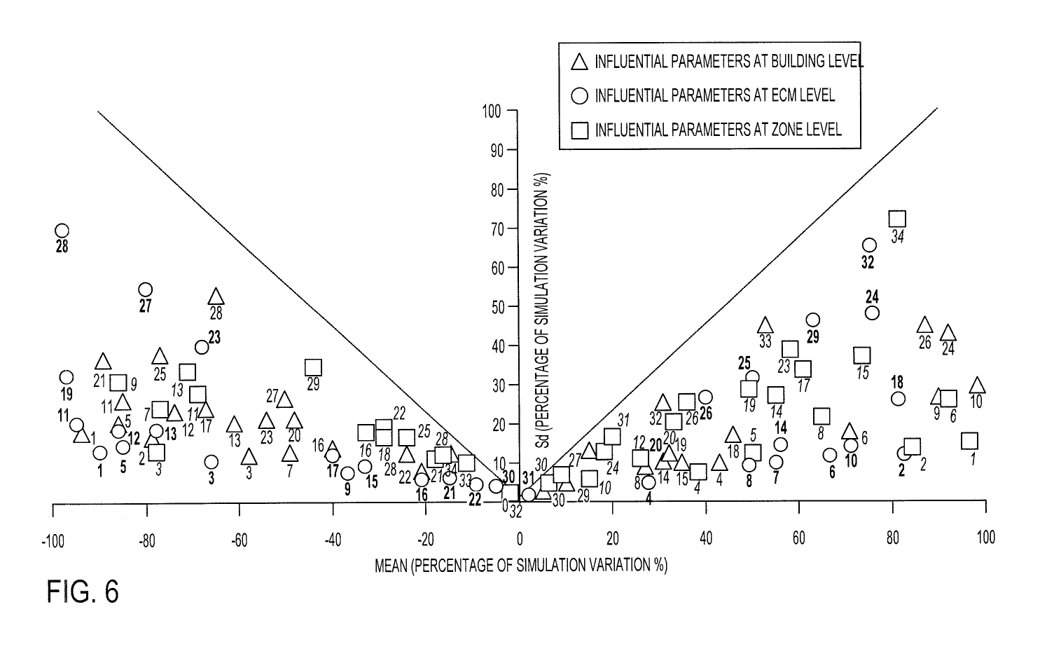

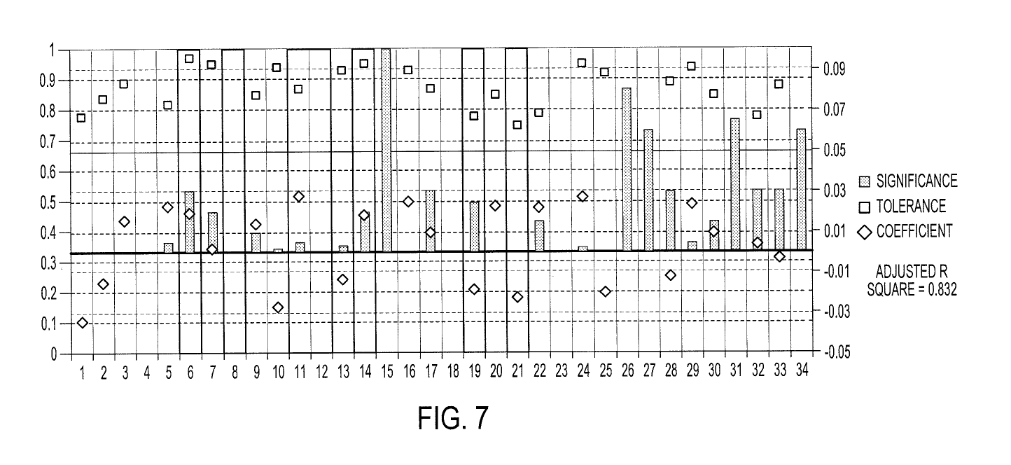

Matlab was used in the experiment to implement the discrepancy analysis and discrepancy minimization for calculating the values of adjustable parameters. In this experiment, there were 29 adjustable parameters for the building level simulation, 24 adjustable parameters for ECM level simulation, and 26 adjustable parameters for zone level simulation (see unshaded and red-shaded parameters in Tables 2a-2c), which were assumed to be responsible for the majority of the discrepancy between the simulated and measured energy consumption. This step analyzed where the major errors lied based on a regression fitting by weighing the relations Ŷ_{building level}=a₀+a₁x₁+a₂x₂+ . . . +a₂₉x₂₉+ε_{building level}, Ŷ_{ECM level}=b₀+b₁z₁+b₂z₂ . . . b₂z₂ . . . ε_{ECM level} and Ŷ_{zone level}=c₀+c₁z₁+c₂z₂ . . . +c₂₆z₂₆+ε_{zone level} and testing the statistical significance. Specifically, Ŷ_{level i} is the simulation discrepancy at the i level, a₀, b₀, c₀ are the constant, aₙ, bₙ, cₙ are the coefficients for regression respectively, and c, is the residual of the regression function for level i simulation. Actual energy consumption data, collected from January 1st to March 10th, were used for the multi-regression analysis, and the results were presented in FIGS. 7-9. Each adjustable parameter was normalized within [0,1]. Random sampling was used to select the samples within the predefined parameter ranges to form the independent variables. The partial regression coefficients and intercepts were calculated with the method of least square. The larger the calculated coefficient is, the more contribution a parameter has to the discrepancy. If a certain parameter has no significant influence in a multi-linear regression formula, its coefficient was given the value of 0. A positive coefficient indicates an overestimation, while a negative indicates an underestimation in the simulated results (FIGS. 7-9). The results showed that a parameter with high influence on simulation results in the sensitivity analysis does not mean high influence on simulation discrepancy in the regression analysis.

The two criteria for analyzing the influences of parameters and their mutual relations were then investigated. The first criterion is the adjusted determination coefficient (Adjusted R Square), used to represent the percentage of a dependent variable (energy simulation discrepancy) that can be explained by the independent variables (adjustable parameters). In this case study, approximately 83.2% of the building level energy discrepancy, 81.8% of the ECM level energy discrepancy, and 80.7% of the zone level energy discrepancy could be attributed to those adjustable parameters. The second criterion is the tolerance for the multicollinearity between the parameters. The smaller the tolerance value is, the stronger the multicollinearity appears. The results also demonstrated that significant adjustable parameters were all independent at all the three levels (dots in FIGS. 7-9). Similar to the conclusion in the sensitivity analysis that there was no parameter interaction and all the adjustable parameters were linearly related to the simulation discrepancy. In addition, the significance tests (at a 95% confidence level) for assessing statistical significance of multi linear regression equations and coefficients were also explored. F-test results (FIGS. 7-9) showed the three multi linear regression equations all had F values larger than the critical values (F_{building}=1.47, F_{ECM}=1.52, F_{zone}=1.82), demonstrating the regression models were statistically significant and the simulation discrepancies were mainly impacted by the adjustable parameters. Based on the T-test results except for the parameters of Solar Heat Gain Coefficient (ID #15), Fresh Air Introduction Rate (ID #26), Maximum Zone Wind Speed (ID #27), Ground Temperature (ID #31), and Reference Barometric Pressure (ID #34) in building level regression, the parameters of Supply-Air-to-Zone-Air Temperature Delta (ID #14), Fraction of Convective Internal Loads (ID #18), Effective Air Leakage Area (ID #27) and Visible Absorptance (ID #32) in ECM level regression, and the parameters of Zone Cooling Sizing Factor (ID #9), Minimum Surface Convection Heat (ID #15), Minimum Airflow Fraction (ID #20), Delta Adjacent Zone Air Temperature (ID #24), Airflow Convergence Tolerance (ID #27) and Surface Albedo (ID #31), the coefficients of other individual parameters were all statistically significant (FIGS. 7-9), indicating the insignificant parameters are successfully differentiated from significant parameters (Tables 2a-2c), which account for the simulation discrepancy.

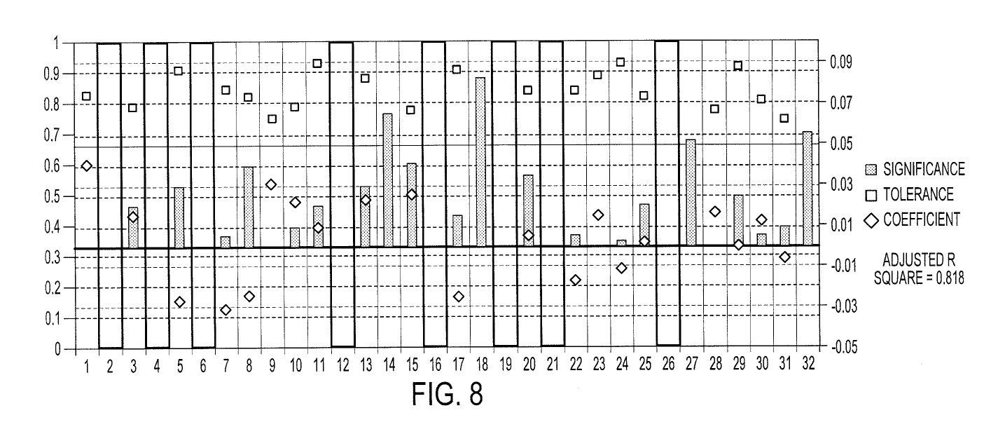

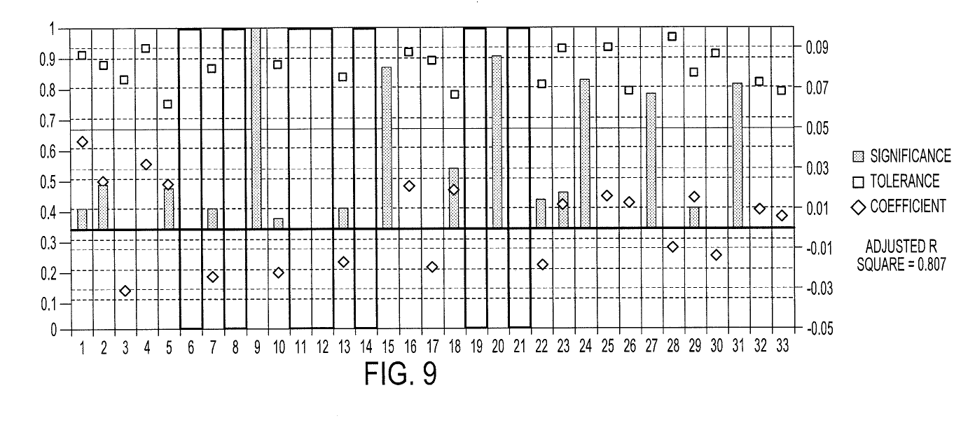

Statistically significant parameters were processed by multi-objective programming to determine the values within value ranges that could minimize the simulation discrepancies. The energy consumption data from January 1st to Mar. 10, 2013 were used for model calibration, while the data from March 15th to Nov. 15, 2014 were used for evaluating the performance of multiple level simulation calibration (objective 1), and the data from March 11st to Apr. 28, 2013 were used for evaluating the model robustness by mixing the ground truth of two ECMs (objective 2) (FIG. 10). In this case study, hourly simulation was conducted and hourly tolerances (from IPMVP, FEMP and ASHRAE) were used for evaluating daily MSE and CV (RMSE). For objective 1, one month was used as the period for calculating the hourly MBE and CV (RMSE); for objective 2, seven days (one week) were considered as one period for calculating the hourly MBE and CV (RMSE). Specifically, the data for calibration (from January 1st to March 10th) were used for generating solutions and choosing the weights for discrepancies at three levels. With different preferences, different combinations of weight values were searched iteratively until the weighted discrepancies converged (FIG. 11).

Six possible combinations of weights were tested for building level preferred optimization, ECM level preferred optimization and zone level preferred optimization. However, the different preferences did not converge to the same result in this case study. A possible reason could be that one level simulation accuracy had a conflict with another. Since each objective function has its own parameters that do not exist in another objective function, different weight preferences that are assigned to the three functions may result in different solutions for those parameters. Solutions are the sets of values for parameters that could minimize either the objective functions (building level, ECM level, or zone level) or the weighted objective function. There might be one or multiple solutions as different combinations of values may achieve the same results. Based on the results in FIG. 11, ECM level preferred solutions (3rd combination with the relative preference of ECM level>zone level>building level) could achieve lower simulation discrepancy and converge faster. (w_{building}=0.27, w_{ECM}=0.39; w_{zone}=0.34) was selected for further evaluation. Linear programming was then used to find the initial solution. The effective solutions were also searched and the corresponding function outputs were then compared to conclude which solution could minimize weighted simulation discrepancy.

To illustrate the difference in estimation of parameters at different levels and how they are eventually combined into one model, the following example is provided. After the initial modeling (step 402, FIG. 4), for example, if Wall U-factor existed in the lists of influential parameters for all three levels based on the sensitivity analysis (step 404, FIG. 4), it was considered to significantly contribute to the accuracy of the final model at the building level, ECM level and the zone level. Since this parameter cannot be calculated by parameter estimation (step 408, FIG. 4), it is an adjustable parameter and should be determined by discrepancy analysis (step 414, FIG. 4) and discrepancy minimization (step 418, FIG. 4). After decomposing the discrepancies between the simulated and actual energy performances to the adjustable parameters, if Wall U-factor was statistically significant for contributing to the simulation discrepancies at all three levels, its weight for either one of the three levels of simulation discrepancy can be recognized through a regression analysis. Multi-objective optimization was then conducted to find the final value of U-factor that could synergize with other parameters to minimize weighted simulation discrepancies of the three levels. Its varying values should be limited within its parameter ranges and are recommended not to be far from the default values set in Energyplus.

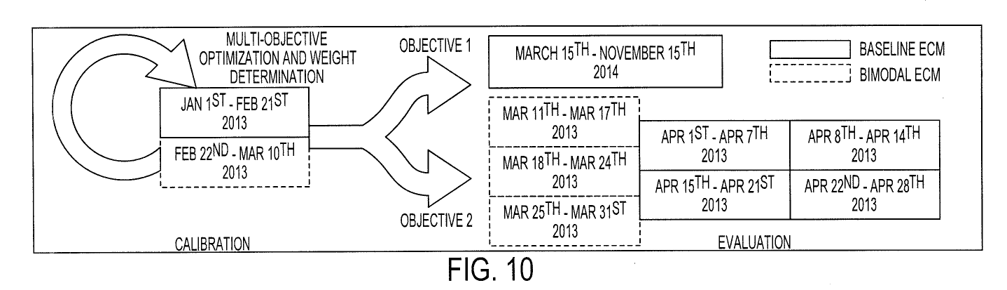

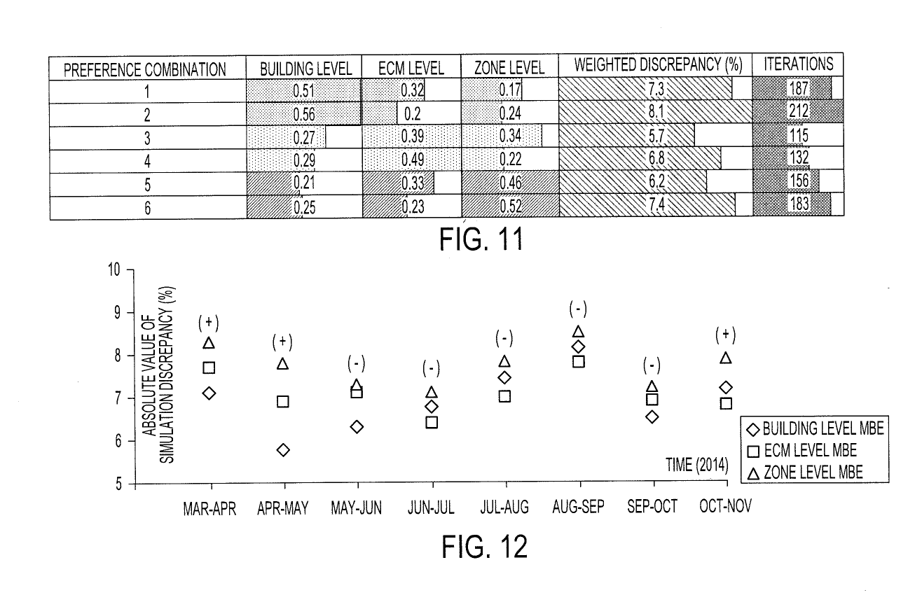

To evaluate the performance of the experimental calibrated building model at multiple levels, eight months' data from Mar. 15, 2014 to Nov. 15, 2014 were collected for validating multi-level simulation accuracy, and the results are shown in FIGS. 12 and 13. In general, the calibrated model could simulate long-term energy consumption with an absolute hourly error (MBE value) below 8.1% (6.9% for average) at the building level, below 7.8% (7.1% for average) at the ECM level, and below 8.5% (7.7% for average) at the zone level for all of the tested months. MBE values were slightly lower than the CV (RMSE) values. One explanation could be that simulation overestimation might be compensated by the underestimation. The variations of the simulation discrepancy were not significant (12.2% for average at the building level, 11.1% for average at the ECM level and 12.8% for average at the zone level). All of the CV (RMSE) values were within the tolerances regulated by the ASHRAE, FEMP and IPMVP. As the evaluation results (test performance) were consistent with the calibration results (training performance) in FIG. 11, the calibrated model was not overfit. The results also demonstrated the consistency of calibrated building energy model over time and season.

Based on the results, the modeled thermal characteristics may not fit the actual characteristics of the building so well, as the energy model overestimated the energy consumption at all of the three levels when there was not much cooling required (March to May and October to November). However, during the seasons where cooling was required (May to October), the building level simulation tended to underestimate the energy consumption, possibly because the performances of HVAC plants and systems were overestimated to be more energy efficient than they were in reality. Meanwhile, ECM level simulation may underestimate the control inefficiency and it may also lack the consideration of thermal influences of the adjacent spaces controlled by another AHU. Zone level simulation assumed to have less space heat gains than the actual end use demand and was influenced by the overestimated HVAC system performance as the outside temperature increased. Since not all the zones were selected for calibration and only average zone energy consumption was considered, simulation results for individual zones may deviate from the measured energy consumption, resulting in zone level simulation to be higher in MBE and CV (RMSE) compared to the ECM level and the building level simulation.

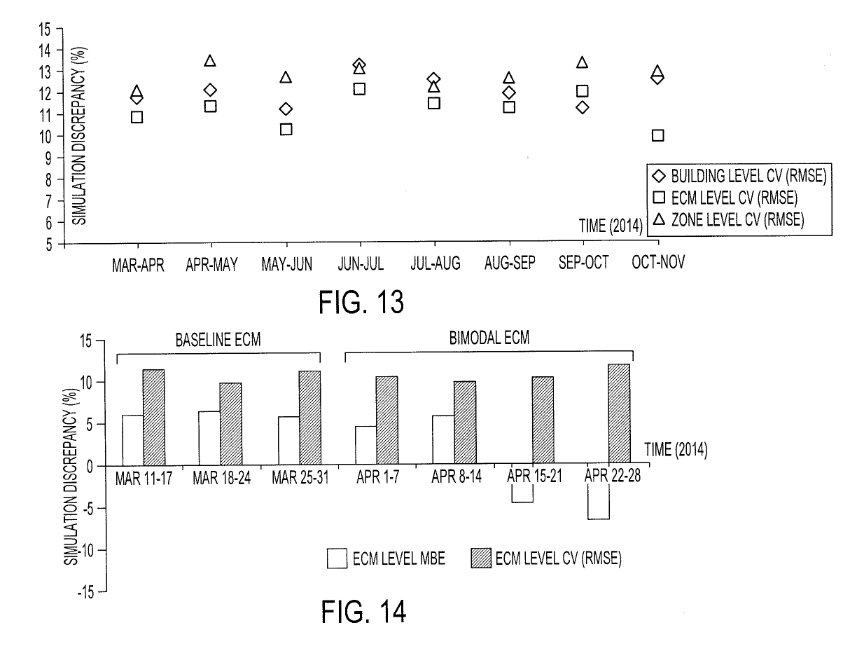

In order to explore whether the energy model calibrated using ground truth energy data from mixed ECMs, could consistently simulate energy performance for each ECM, the period from March list to April 30th was selected for evaluation of the second objective, during which three weeks were operated by the bimodal ECM in the 14 zones and the rest were operated by the baseline ECM. The corresponding MBE values and CV (RMSE) values were calculated at the ECM level and presented for comparing the simulated results with actual energy performance (FIG. 14). It can be concluded that the hypothesis should be accepted that energy model calibrated under two ECMs could consistently simulate actual energy consumption under either ECM independently.

At the ECM level, the differences of averaged MBE between baseline ECM and bimodal ECM were 0.7% (with the absolute difference below 1.8% between any pair), and the averaged differences of CV (RMSE) were 0.4% (with the difference below 1.9% between any pair), which indicated that the calibrated model was robust enough to the changes resulting from the building being operated differently.

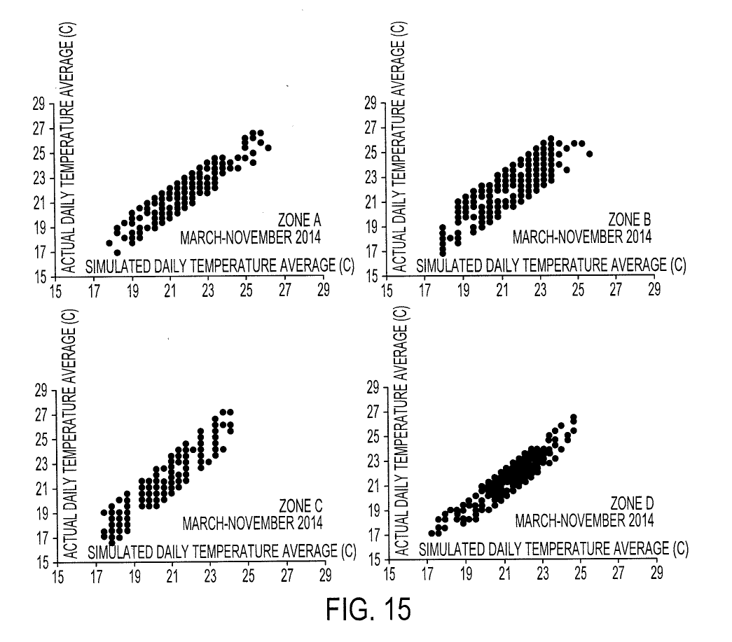

In order to evaluate the quality of simulation for thermal conditions, four zones in the case study building were randomly selected. For each zone, the comparisons between simulated average daily temperatures and actual average daily temperatures from March 15th to November 15th were presented in FIG. 15. Since all the points were closely around the line y=x (average absolute value is 2.1° C. for Zone A, 2.7° C. for Zone B, 3.1° C. for Zone C and 1.9° C. for Zone D), the comparison results demonstrated that the thermal conditions were well simulated by the calibrated energy model.

Summarily, the actual calibration process guided by the proposed calibration framework used evidence and statistical learning steps. Evidence was used to build the energy model and statistical learning was used to reduce the simulation discrepancy. The propose calibration framework does not need retraining when changes are made to building conditions, operations and conservation measures; meanwhile it avoids the trial-and-error process, which requires significant time, effort and expertise. The presented framework is a generalizable method, which is not specific to any building type or building system type. Although EnergyPlus was used as the simulation program to validate the calibration method, the method is not designed for EnergyPlus and could be used with other simulation programs.

References to “various embodiments,” in “some embodiments,” “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

The foregoing description of the disclosed example embodiments is provided to enable any person of ordinary skill in the art to make or use the present invention. Various modifications to these examples will be readily apparent to those of ordinary skill in the art, and the principles disclosed herein may be applied to other examples without departing from the spirit or scope of the present invention. The described embodiments are to be considered in all respects only as illustrative and not restrictive and the scope of the invention is, therefore, indicated by the following claims rather than by the foregoing description. All changes which come within the meaning and range of equivalency of the claims are to be embraced within their scope.

What is claimed is:

1. A method for simulating energy use in a building, the method comprising:
generating a building model based on building data associated with the building, the building model having a plurality of levels each representing a scope of energy use, the building model simulating the energy use in the building based on one or more values corresponding to one or more input parameters to produce building model simulation results;
receiving detected energy data associated with actual energy use in the building over a period of time;
performing a sensitivity analysis using the building model to identify one or more influential parameters affecting building model simulation results;
performing a discrepancy analysis across the plurality of levels using the building model and the detected energy data to identify one or more adjustable parameters from the one or more influential parameters;
determining values for the identified one or more adjustable parameters to minimize discrepancies at the plurality of levels; and
incorporating the values for the identified one or more adjustable parameters into the building model to provide a calibrated building model for simulating energy use in the building.

2. The method of claim 1, further comprising:
identifying one or more observable parameters from the one or more input parameters;
determining one or more respective values for the one or more observable parameters based on the building data; and
incorporating the one or more respective values for the one or more observable parameters into the building model.

3. The method of claim 2, further comprising:
identifying one or more estimable parameters from the one or more influential parameters;
determining one or more respective values for the one or more estimable parameters based on the one or more respective values for the one or more observable parameters; and
incorporating the one or more respective values for the one or more estimable parameters into the building model.

4. The method of claim 1, further comprising displaying, on a display, the improved calibrated building model.

5. The method of claim 1, wherein the performing the sensitivity analysis comprises ranking the one or more input parameters by impact of a change of a particular parameter on the energy use in the building.

6. The method of claim 5, wherein the ranking the one or more input parameters comprises performing multiple simulations using the building model and adjusting, for each simulation, a single input parameter from the one or more input parameters to determine the impact of the change of the single input parameter on the energy use in the building.

7. The method of claim 1, wherein the performing the discrepancy analysis comprises:
determining a simulated energy use for various random test values of each parameter from the one or more influential parameters using the building model;
comparing, the simulated energy use with actual energy use based on the detected energy data; and
identifying the one or more adjustable parameters based on the comparison of the simulated energy use with the actual energy use.

8. The method of claim 1, wherein determining the values for the identified one or more adjustable parameters to minimize discrepancies at the plurality of levels comprises performing multi-objective programming.

9. A method for calibrating a building model used to simulate energy use in a building having a plurality of levels each representing a scope of energy use, the building model simulating the energy use in the building based on values of one or more input parameters, the method comprising:
receiving, by a building simulation unit, detected energy data associated with the building over a period of time;
performing, by a sensitivity unit, a sensitivity analysis using the building model to identify one or more influential parameters from the one or more input parameters;
performing, by a discrepancy processing unit, a discrepancy analysis across the plurality of levels using the building model and the detected energy data to identify one or more adjustable parameters from the one or more influential parameters;
determining, by the discrepancy processing unit, values for the identified one or more adjustable parameters to minimize discrepancies at the plurality of levels; and
incorporating, by a calibration unit, the values for the identified one or more adjustable parameters into the building model to provide a calibrated building model for simulating energy use in the building.

10. The method of claim 9, further comprising:
identifying, by the calibration unit, one or more observable parameters from the one or more input parameters;
determining, by the calibration unit, one or more respective values for the one or more observable parameters based on building data associated with the building; and
incorporating, by the calibration unit, the one or more respective values for the one or more observable parameters into the building model.

11. The method of claim 10, further comprising:
identifying, by the calibration unit, one or more estimable parameters from the one or more influential parameters;
determining, by a parameter estimation unit, one or more respective values for the one or more estimable parameters based on the one or more respective values for the one or more observable parameters; and
incorporating, by the calibration unit, the one or more respective values for the one or more estimable parameters into the building model.

12. The method of claim 9, further comprising displaying, on a display, the improved calibrated building model.

13. The method of claim 9, wherein the performing the sensitivity analysis comprises ranking the one or more input parameters by impact of a change of a particular parameter on the energy use in the building.

14. The method of claim 13, wherein the ranking the one or more input parameters comprises performing multiple simulations using the building model and adjusting, for each simulation, a single input parameter from the one or more input parameters to determine the impact of the change of the single input parameter on the energy use in the building.

15. The method of claim 9, wherein the performing the discrepancy analysis comprises:
determining a simulated energy use for various random test values of each parameter from the one or more influential parameters using the building model;
comparing, the simulated energy use with actual energy use based on the detected energy data; and
identifying the one or more adjustable parameters based on the comparison of the simulated energy use with the actual energy use.

16. The method of claim 9, wherein determining the values for the identified one or more adjustable parameters to minimize discrepancies at the plurality of levels comprises performing multi-objective programming.

17. A system for simulating energy use in a building, the system comprising:
a modeling unit configured to generate a building model based on building data associated with the building, the building model having a plurality of levels each representing a scope of energy use, the building model simulating the energy use in the building based on one or more values corresponding to one or more input parameters to produce building model simulation results;
a calibration unit connected to the modeling unit and configured to receive detected energy data associated with the building over a period of time;
a sensitivity unit connected to the calibration unit and configured perform a sensitivity analysis using the building model to identify one or more influential parameters from the one or more input parameters; and
a discrepancy processing unit connected to the calibration unit and configured to:
perform a discrepancy analysis across the plurality of levels using the building model and the detected energy data to identify one or more adjustable parameters from the one or more influential parameters, and
determine values for the identified one or more adjustable parameters to minimize discrepancies at the plurality of levels,
the calibration unit further configured to incorporate the values for the identified one or more adjustable parameters into the building model to provide a calibrated building model for simulating energy use in the building.

18. The system of claim 17, wherein the calibration unit is further configured to:
identify one or more observable parameters from the one or more input parameters;
determine one or more respective values for the one or more observable parameters based on the building data; and
incorporate the one or more respective values for the one or more observable parameters into the building model.

19. The system of claim 18, further comprising a parameter estimation unit configured to determine one or more respective values for one or more estimable parameters based on the one or more respective values for the one or more observable parameters, and wherein the calibration unit is further configured to identify the one or more estimable parameters from the one or more influential parameters, and incorporate the one or more respective values for the one or more estimable parameters into the building model.

20. The system of claim 17, further comprising a display configured to display the improved calibrated building model.
